(19) United States
(12) Patent Application Publication
(10) Pub. No.: US 2010/0114939 A1
(43) Pub. Date: May 6, 2010

(54) SOFTWARE TEST MANAGEMENT SYSTEM AND METHOD WITH FACILITATED REUSE OF TEST COMPONENTS

(76) Inventors: Elad SCHULMAN, Tel Aviv (IL); Yoav Eilat, Mountain View, CA (US); Yossi Rachelson, Yehud (IL); Tal Halperin, Rishon Le-Zion (IL); Michael Kossowsky, Beit Shemesh (IL)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/258,044

(22) Filed: Oct. 24, 2008

(51) Int. Cl. G06F 7/06; G06F 17/00

(52) U.S. Cl. 707/769; 707/E17.005

(57) ABSTRACT

A system and appertaining method is provided for identifying a software test component for reuse in a system whose attributes are stored in a repository, based on the attributes of a component that is in the process of being developed or has been developed. A checking algorithm looks to a repository for a new software test component to see if a similar one exists by comparing various attributes of the new component to attributes of a stored component. If a match is found, the developer is notified and thus uses the stored component instead of the new one.

### BACKGROUND

A test management system involves the use of test components that must be developed in order to perform tests on a system under development.

When creating a new test component in a test management system (in a manual or automatic way), no adequate tools exist to easily determine if a similar component already exists in the system. In the case of manual creation by an end-user, generally the end-user has to manually review existing components within the system or search using a sub-optimal search criteria; if a suitable component is found, it can be manually retrieved and reused.

When a test management system contains a large number of testing components (which is typical of large scale systems) that search is almost impossible, since, in order to find a suitable component for reuse, almost every single component needs to be checked, and each of their elements must be examined. When the user fails to find a similar component, he will create a new one. This occurs despite the fact that there may be an identical or very similar component already in the system.

### DESCRIPTION OF THE DRAWINGS

The following figures illustrate the present invention as implemented in various preferred embodiments.

FIG. 1 is a block diagram illustrating the basic elements of a test management system according to an embodiment of the invention;

FIG. 2 is a flowchart illustrating the process according to an embodiment of the invention;

FIG. 3 is a block diagram illustrating an exemplary application-under-test component script that performs processing steps and has parameters;

FIG. 4 is a pictorial diagram of an exemplary application-under-test screen display that illustrates screen area regions that make up the screen display;

FIG. 5 is a pictorial diagram of an exemplary application-under-test screen area that comprises various user interface elements;

FIG. 6 is a screen capture image of an exemplary screen display that illustrates a dialog box that a user would use when attempting to add a new component to the component repository;

FIG. 7 is a screen capture image of an exemplary screen display that illustrates the system indicating that similar components exist in the component repository;

FIG. 8 is a screen capture image of an exemplary screen display that illustrates a display of the component comparison; and

FIG. 9 is a screen capture image of an exemplary screen display that illustrates the component creator opting to utilize an existing component.

### DETAILED DESCRIPTION OF THE EMBODIMENTS

Various embodiments of the present invention provide an advantageous method for implementing in any test management system containing tests that are broken into smaller components as testing entities.

Accordingly, a method is provided for identifying a software test component for reuse in a system, comprising: collecting and storing a plurality of identifiable attributes for a plurality of components in a component attribute repository; providing identifiable attributes for a new software component to a checking algorithm that executes on a processor of a computer; comparing, by the checking algorithm, the attributes for the new software component against like said attributes of components stored in the component attribute repository; determining, according to a predetermined criteria, if the new software component matches one or more of the plurality of components; and providing an output to a user identifying the matched one or more of the plurality of components.

The identifiable attributes may include identifiers of screens or other user interface elements. The method may further comprise that if the new software component matches one or more of the plurality of components, utilizing, by the user, a component that is one of the matching components. The method may further comprise that if the new software component does not match one or more of the plurality of components, then storing attributes of the new component in the component attribute repository.

A at least one of the attributes may be stored as metadata. The comparing may comprise performing a text-based comparison on the metadata. At least one of the attributes may be obtainable from an application program interface (API). The method may further comprise calculating a degree of similarity between the new software component and at least one of the plurality of components. The method may further comprise presenting to the user the degree of similarity.

The method may further comprising submitting the new software component for saving, wherein the submitting triggers the step of providing identifiable attributes. The method may further comprise utilizing operational steps of the new software component in determining if the new software component matches one or more of the plurality of components. Furthermore, the method may comprise utilizing a sequencing of the operational steps of the new software component in determining if the new software component matches one or more of the plurality of components.

The method may further comprise that the comparing considers (or, in an alternate embodiment, includes all) comparison criteria selected from the group consisting of: a) similarity of screen or screen area within an application under test; b) a similarity of scripts; c) a similarity of steps; d) a similarity of order or sequencing of those steps; e) a similarity of input parameters; f) a similarity of output parameters; g) a similarity of input values for the parameters; h) a similarity of output values for the parameters; i) a similarity of check-points; and j) a structural similarity of screen objects.

The method may further comprise determining, by the user and at least one further person, whether to replace a component in the plurality of components with the new component when there is a match. The method may further comprise performing an initial knock-out search based on comparing a screen ID of the new component with screen IDs of components associated with the repository. The method may further comprise calculating a degree of similarity between the new software component and at least one of the plurality of components; and presenting, to the user, visual indicators related to the degree of similarity.

It is desirable that when a new component, such as a user interface screen display, has been designed by a designer (either manually or in an automated way), before saving that new component, an automatic search is performed for existing testing components in the testing product in order not to create another copy of that component in the repository where components are stored, and reuse the existing copy that already exists.

By way of example, a component designer might wish to design a login screen comprising two fields: a username and a password. In the manual design, the component creator might expressly draw out the dialog box, add a username and password field descriptor, and then add the actual fields for accepting the user input. In the automated mechanism, the design may be implemented according to some form of recording an action, macro, or learning, based on a user's actions.

It should be noted that there are two broad aspects to the components that can be considered in the system: the first deals with the structure of the component (for a user interface element, its layout in terms of, e.g., windows, fields, buttons, and the parameters used to define these); the second deals with functioning and sequencing in the form of steps that are performed and the ordering of those steps (e.g., the order of entry for various fields of a particular dialog box, etc.), as well as relevant script files. It is noted that in some situations, script files can define user interface elements, and can also implement functional aspects.

It is possible to determine a degree of similarity by examining just one or the other (structure or function/sequence), although the most robust comparison will take both aspects into account when performing the comparison.

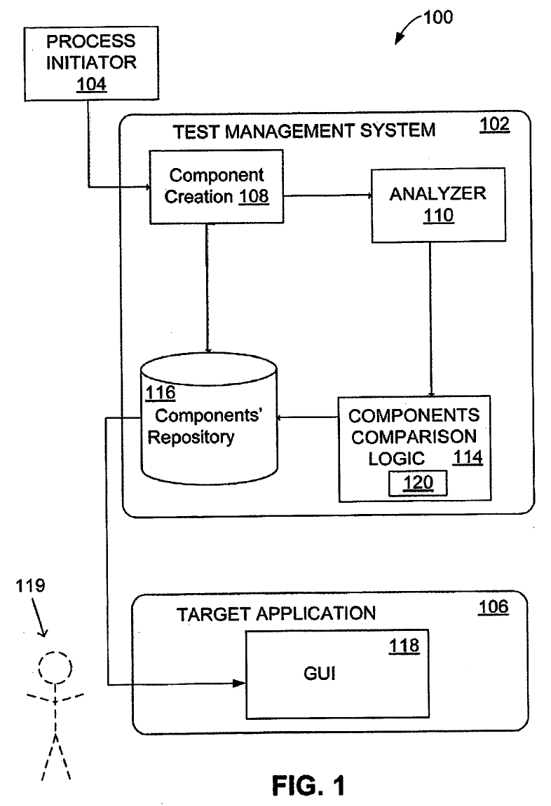

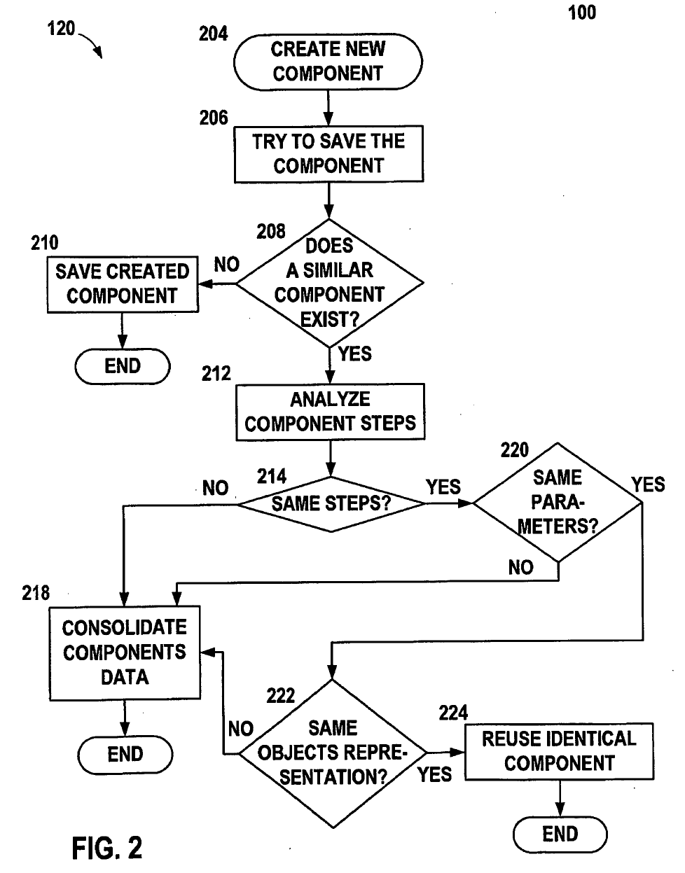

Referring to FIGS. 1 and 2 that illustrate the overall system 100 and associated method, a process initiator (or “component developer”) 104 (who may be a tester, QA engineer, Subject Matter Expert, or Business Analyst), creates a new component 108, 204 that is to be used within a test management system 102. The created 108 component is designed to be ultimately utilized in a target application 106 by a system user 119. The target application 106 may utilize a graphical user interface (GUI) 118 for accessing the component 108. Additionally, the process initiator 104 can also, prior to creation of the component 108, search for matching components of a proposed component 108 in the component repository 116. This could be achieved by fully or partially designing the component or specifying all or some of the component's attributes (and partial hits on components in the repository could be indicated as well).

Once the component is created 108, by the process initiator 104, the initiator 104 tries to save the component 206. A check is performed to determine if a similar component exists 208. If not, the component is saved 210, otherwise, it is subjected to further analysis.

If a similar component is found 208 based on some predetermined criteria (using, e.g., attributes, such as a screen ID or field IDs), then the operational steps of the found component are compared against the new component and analyzed 212. If the same steps are not found 214 (e.g., same layout, but different order entry), then the components data may be consolidated 218 (brought together). If the same steps 214 are found, then a test is made to determine the sameness of the parameters (number and type of parameters). If the same parameters are found 220, then a test is made to see if the same objects representation can be found 222. If yes, then the identical component 224 can be reused, and if not, an offer can be made to reuse the component-some of the information may need to be consolidated 218, which could include, e.g., joining certain steps not present in the reuse candidate component and/or making some steps or other attributes optional.

Using the login screen as an illustrative example, a component developer creates a new login component or at least defines partial or complete attributes of the component for the search, and checks to see if a similar component exists. A check is made in the component repository to see if a component matching the screen ID or field IDs is present. If not, it can be determined that the component does not exist, and the newly created component is stored in the component repository.

If it is determined that a similar component exists (e.g., one with a similar screen ID and fields), then the component steps and order may be analyzed (e.g., enter the username first, followed by the password). The entry order, in this case, can possibly be specified by the screen design tool, i.e., the field entry order is specified in the tool used to create the dialog box, and this entry order information is stored with the component and can be accessed. The test for the same parameters could be, e.g., determining if the user's name or the user's social security number is requested. If the parameters match up, then it is clear, in this example (where the entry steps and order match up as well), that the new component matches the component in the repository, and thus should be reused. As discussed below, the degree of similarity could also be factored in so that an exact match on both the parameters, steps, and entry order are not required for the replacement.

The new component may be automatically (prior to entry into the component repository 116) subjected to an analyzer 110 that performs a comparison 114 of the constituent elements (attributes) of the created component 108, based on information from within a repository (database) of other system components 116. To the extent that the created component 108 is determined to be unique, it is then stored in the repository 116, 210.

It should be noted that the results of the flowchart in FIG. 2 could produce various indications of degrees of similarity. By way of example, if similar attributes (e.g., screen IDs or fields) exist, but the operations steps and ordering are different, the degree of similarity might be assigned 50%, whereas if similar attributes exist and similar operation steps exist, but they are of a different order, then the degree of similarity assigned might be 75%, and only when attributes, steps, and step orders are identical is a 100% degree of similarity assigned. Furthermore, other aspects might be used to calculate how similar the components are. For example, a new username-only dialog box might match a username-password in the repository at a 25% level. The criteria for a degree of matching can be specified in advance, and can be relatively arbitrary, with the key point being that a “match” is not necessarily an all-or-nothing thing.

In the event of a potential conflict (e.g., that a newly created component is deemed “better” than a preexisting component that is very similar), in one embodiment, a discussion among the developers can ensue, with a decision being made as to whether to keep and use the existing component in the repository, and discard the newly created component, replace the existing component in the repository, or simply add the new component to the repository and have both the similar component and the newly added component come up with matches when a further new component is similar. It is also possible that this would trigger the development of a hybrid component that contains the best of both. Note that if the match of the new component and the repository component comes up as 100%, this discussion will likely not have to take place, since the components are identical, and the system can automatically make the decision for reuse.

In an alternate embodiment, a repository manager or other authoritative overseer could make the determination as to whether a similar component in the database gets overwritten, or whether one of the other identified actions should take place, as discussed above.

If the application under test (AUT) (target application) has meta-data on its pages/screens, then this is very helpful to the search process, as more information is available on the elements that are contained in each component 502. By way of example, each control has metadata such as the program name that implemented it, a screen ID, each control itself, etc.

However, the presence of metadata is not essential in order to make the comparison between two components. Each component can contain objects/elements that are visible to the testing world. For example, the HTML code defining a dialog box on a web page would contain metadata that is visible to the testing world. A text search on metadata on such files could be one way that this visibility is utilized. Note that with such metadata, the components and respective elements could easily be mapped into a database. A grouping of respective elements can easily be provided, such as associated radio buttons with a particular control by, e.g., examining the metadata. In addition to a text search on HTML, in a SAPGUI®-based system, one could also look to the application program interface (API) to obtain the information on the screen. Other techniques could be implemented as well.

When comparing two components (via source code, script, object code, etc.), or when searching the component repository 116 for a component with certain characteristics or attributes, the following aspects and elements can be compared and considered as comparison criteria, although no particular aspect or combination is essential—as noted previously, for all of these comparison criteria, a determination can be made by degree, and not necessarily as an all-or-nothing criteria, or a threshold value/determination could be applied to each as well:
a) (if the component is screen-/display-based) similarity of screen or screen area within the AUT (although this is primarily considering functional aspects (behavior), e.g., a login box with the same attributes, other less relevant aspects could be considered as well, such as position, size/pixel dimensions, background, etc.;
b) (if the component is built from a testing script) similarity of scripts (which could be determined, e.g., by the automated nature of creation and its respective wrapping with the component, and the similarity could be determined by done, e.g., by a text compare on the script source, looking at names, parameters, data types, etc.);
c) (if the component is “step driven”), similarity of steps and similarity of order/sequencing whether the two components have similar steps, and if the steps are similar, whether they are performed in the same order or contain similar sequencing;
d) similarity of input parameters (within the component, e.g., username, password);
e) similarity of output parameters (e.g., message for login success/failure);
f) similarity of values for their parameters (input and output; an output value is a testing mechanism used to output a value of a specific entity's property on the screen during the script's execution. It is marked as another type of a check-point and the user can later on use the extracted property value in other points of his script. For example, when the application generates an important status bar message with a certain document number that will be needed later on in other locations in the script, an output value can be used in order to capture the status bar's document number);
g) similarity of check-points (a check-point is a testing mechanism used to verify that a specific entity on the screen is what the user expects it to be. It is marked as a check-point and the user specifies what this entity should be or what its value should be. For example, for the login screen, it could be checked that a label “Username:” exists next to the username input box).
h) structural similarity of screen objects. A component is built from a representation of objects/information on the screen (e.g., input boxes, radio buttons, etc.).

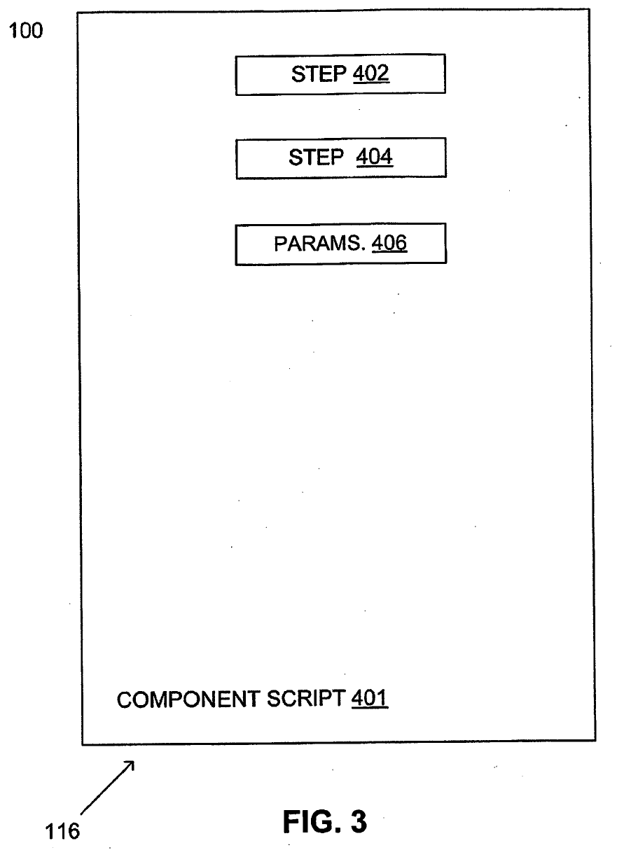

FIG. 3 illustrates an exemplary component under test 116 that comprises a component script 401 that can be used in the comparison. The component script comprises two sequential steps 402, 404 that are used as one basis of comparison noted above. The component script also comprises parameters 406 that are used for the script itself that can further be used in the comparison.

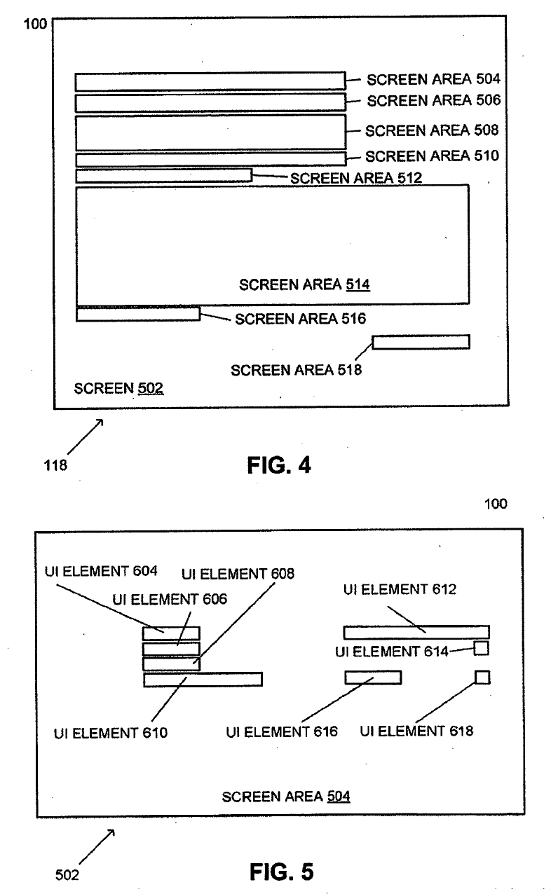

FIGS. 4 and 5 illustrate exemplary components under test that could be used for the above-identified similarity comparisons. FIG. 4 illustrates an exemplary screen component 502 having a plurality of screen areas 504-518. Each screen area 504-518 occupies a specific position and specific size that can be used in determining how similar this particular component 502 is related to those components already stored in the repository. Computer-based algorithms can be used to implement any or all of these features.

FIG. 5 illustrates an exemplary screen area 504 that comprises a plurality of user interface components 604-618. These could be buttons, check boxes, icons, input fields, etc. The type, size, location, default settings, representing label, special application ID, parent information along with other attributes, for example, could similarly serve as a basis for comparison of the component and its structure.

It is important to emphasize that each of the objects/information that is stored within the component is based on the most updated information that is available on the AUT, although in an embodiment of the invention, the system can store different versions of the component so that each change to a component stores a new version of it in the component repository. In this embodiment, older versions can be considered in the similarity comparison or the older versions can simply be accessible for informational purposes.

It is also possible to consider graphical content in the comparison. For example, bitmaps of icons, or other images, artwork, fonts, and other graphical attributes could be used as a part of the comparison.

Furthermore, a component should include all of the information that ever existed on a particular area of the AUT, and each object/information should be available for use, but the user can chose to actually use the object/information (for example, if a specific object had been removed from a screen, it would be hidden, but still available for later use, within that component).

The information on the screen, as discussed above, can be extracted either manually, from an external repository that contains information on the AUT, or in an automated way, via computer-based algorithms, that are present on the testing product.

The system 100 compares two components, and suggests a similar component for reuse. The user can then decide to reuse the suggested component. The system 100 can take all of the information that it can from the newly created component (steps, parameters, objects representation, etc.) and consolidate it into the reused component (e.g., a hybrid component), so that the user has a maximum fit of the reused component to the one that he had initially requested to create.

The system 100 optionally may use some quick search techniques in a pre-screening algorithm in order to quickly reject components that are totally different than the searched component (in order to improve the performance of the system), such as checking for a differing screen ID in combination with a different number of elements, such as input fields.

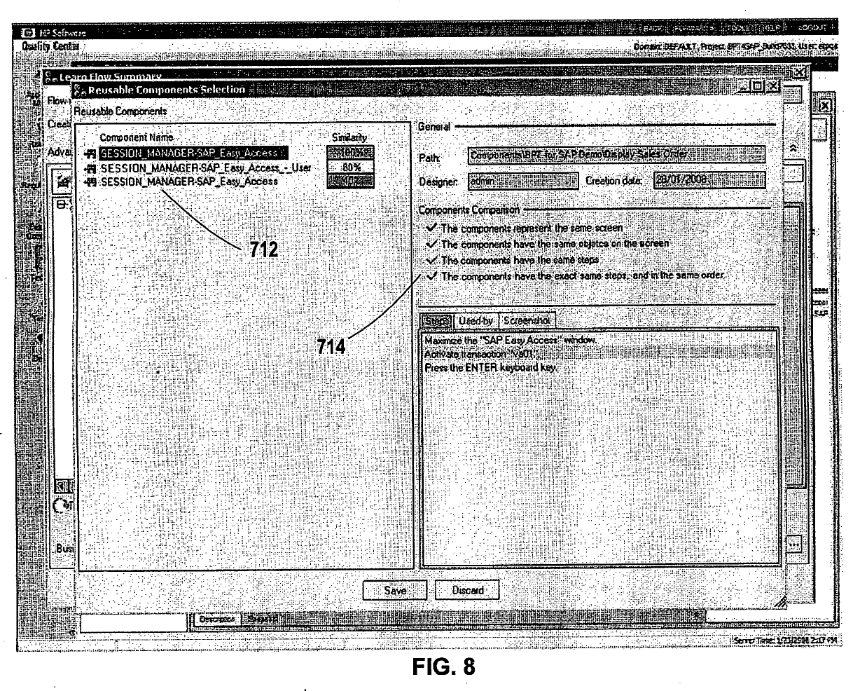

The user may be presented with the comparison information with visual indicators, such as gauges or screenshots, in order to help him understand the degree of similarity between the components (see, e.g., FIG. 8), and know the degree of reusability the old component has.

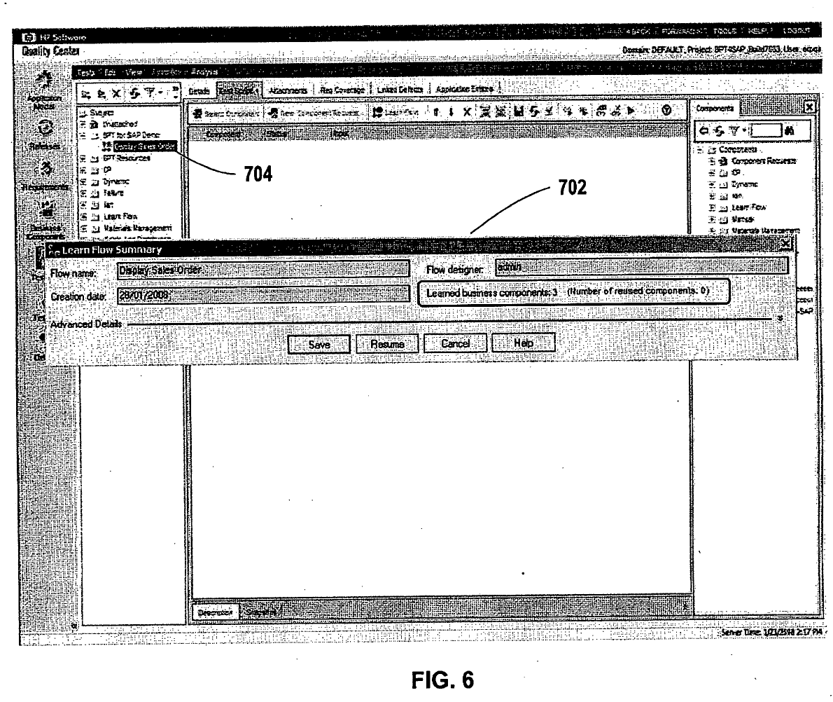

FIGS. 6-9 provide exemplary screen shots for the procedure using a typical Microsoft Windows display format. In FIG. 6, a user attempts to save a newly created object into the database. An initial save new component dialog box 702 is presented to the user as he attempts to save the application-under-test component; the user can navigate through various structured display components 704 (the Display Sales Order component being shown).

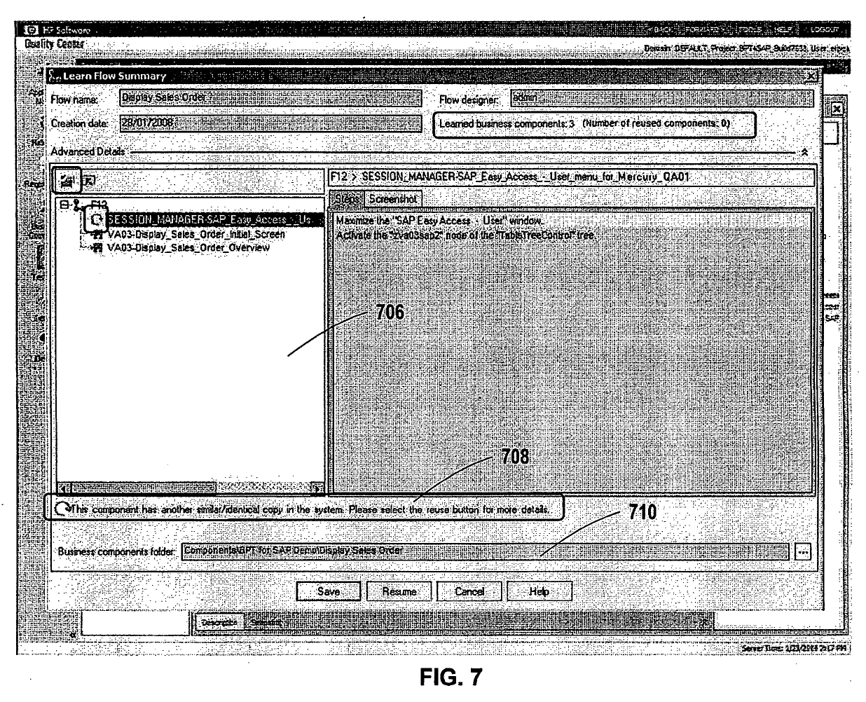

FIG. 7 illustrates that in the matching process, three close matching components are displayed in the matched reusable component display area. Notification is provided to the user in a display region 708. As shown in FIG. 8, if the user requests more information, then the system can provide it. By way of example, the components for SAPS session manager is displayed. In the example shown, three components are provided 712 with their similarity ranked according to a percentage of similarity. A listing of the attributes upon which the component is based can be provided in a component comparison result display area 214.

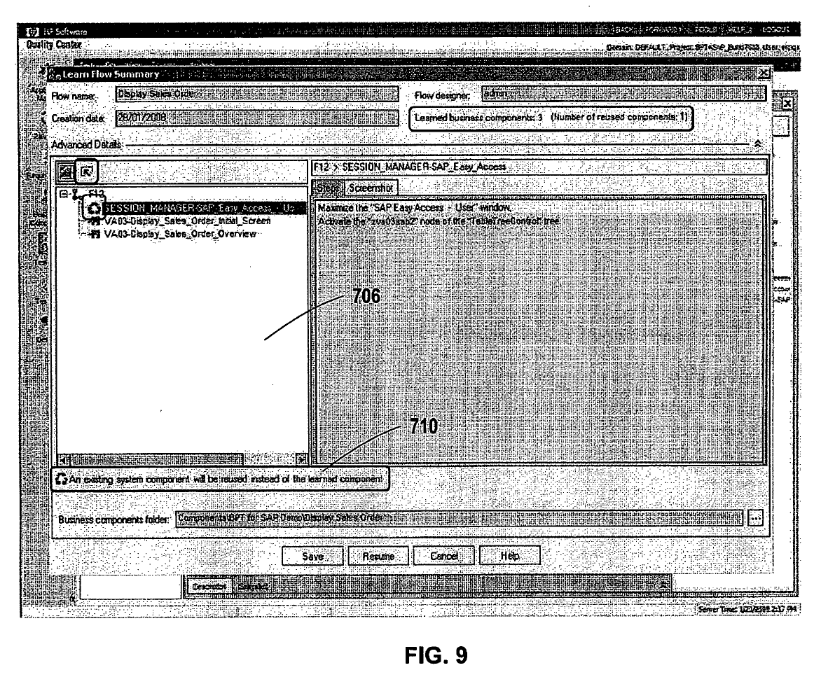

In FIG. 9, the user has chosen the first existing component in the matching reusable components display area 706, and in response, the system provides, in the message display area, an indication that the existing component will be reused.

Other embodiments of the invention can be considered. For example, in addition to utilizing the system when the user is creating a component (in a creation phase), the system could perform checks similar to those described above when the user is performing a change on an existing component, and can also indicate that a change is being made on a component that has similar copies already in the system. At this point, and based on the check results provided, the user can then chose to consolidate the similar components or replace them.

Furthermore, in another embodiment of the invention, if one component has been changed for any reason, all other similar components in the testing system can have some form of notification associated with them so that the user can determine whether he also wants to apply the change to the other similar components as well. Such notification could be in the form of a field within the database or utilize a similar mechanism.

The above described method may be implemented in any form of a computer system. In general, the system or systems may be implemented on any general purpose computer or computers and the components may be implemented as dedicated applications or in client-server architectures, including a web-based architecture. Any of the computers may comprise a processor, a memory for storing program data and executing it, a permanent storage such as a disk drive, a communications port for handling communications with external devices, and user interface devices, including a display, keyboard, mouse, etc. When software modules are involved, these software modules may be stored as program instructions executable on the processor on media such as tape, CD-ROM, etc., where this media can be read by the computer, stored in the memory, and executed by the processor.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like. The word mechanism is used broadly and is not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A method for identifying a software test component for reuse in a system, comprising:
collecting and storing a plurality of identifiable attributes for a plurality of components in a component attribute repository;
providing identifiable attributes for anew software component to a checking algorithm that executes on a processor of a computer;
comparing, by the checking algorithm, the attributes for the new software component against like said attributes of components stored in the component attribute repository;
determining, according to a predetermined criteria, if the new software component matches one or more of the plurality of components; and
providing an output to a user identifying the matched one or more of the plurality of components.

2. The method according to claim 1, wherein the identifiable attributes include identifiers of screens or other user interface elements.

3. The method according to claim 1, further comprising if the new software component matches one or more of the plurality of components, utilizing, by the user, a component that is one of the matching components.

4. The method according to claim 1, further comprising if the new software component does not match one or more of the plurality of components, then storing attributes of the new component in the component attribute repository.

5. The method according to claim 1, wherein at least one of the attributes is stored as metadata.

6. The method according to claim 5, wherein the comparing comprises performing a text-based comparison on the metadata.

7. The method according to claim 1, wherein at least one of the attributes is obtainable from an application program interface (API).

8. The method according to claim 1, further comprising calculating a degree of similarity between the new software component and at least one of the plurality of components.

9. The method according to claim 8, further comprising presenting to the user the degree of similarity.

10. The method according to claim 1, further comprising submitting the new software component for saving, wherein the submitting triggers the step of providing identifiable attributes.

11. The method according to claim 1, further comprising utilizing operational steps of the new software component in determining if the new software component matches one or more of the plurality of components.

12. The method according to claim 11, further comprising utilizing a sequencing of the operational steps of the new software component in determining if the new software component matches one or more of the plurality of components.

13. The method according to claim 1, wherein the comparing considers comparison criteria selected from the group consisting of: a) similarity of screen or screen area within an application under test; b) a similarity of scripts; c) a similarity of steps; d) a similarity of order or sequencing of those steps; e) a similarity of input parameters; f) a similarity of output parameters; g) a similarity of input values for the parameters; h) a similarity of output values for the parameters; h) a similarity of check-points; and i) a structural similarity of screen objects.

14. The method according to claim 1, wherein the comparing includes all of the comparison criteria from the following group: a) similarity of screen or screen area within an application under test; b) a similarity of scripts; c) a similarity of steps; d) a similarity of order or sequencing; e) a similarity of input parameters; f) a similarity of output parameters; g) a similarity of values for the parameters; h) a similarity of check-points; and i) a structural similarity of screen objects.

15. The method according to claim 1, further comprising determining, by the user and at least one further person, whether to replace a component in the plurality of components with the new component when there is a match.

16. The method according to claim 1, further comprising performing an initial knock-out search based on comparing a screen ID of the new component with screen IDs of components associated with the repository.

17. The method according to claim 1, further comprising:
calculating a degree of similarity between the new software component and at least one of the plurality of components; and
presenting, to the user, visual indicators related to the degree of similarity.

18. The method according to claim 1, further comprising performing a text search on a test script comprising HTML code as at least a part of determining the match.

19. The method according to claim 18, wherein the text compare compares at least one of utilizing names, parameters, and data types in the compare.

20. A software test management system for facilitated reuse of test components, comprising:
a component attribute repository for holding at least one of a plurality of components and a plurality of attributes for a plurality of components;
an analyzer comprising an input for accepting a new component or attributes of a new component, the analyzer accessing components comparison logic for determining a degree of similarity of the new component to one of the components of the component attribute repository, and designating a match if the degree of similarity exceeds a certain predefined threshold;
a display for indicating to a user the degree of similarity of the new component to the matching component; and
a mechanism for indicating to the user that the matching test component is to be used in place of the new component.
